(19) United States
(12) Patent Application Publication
(10) Pub. No.: US 2026/0239147 A1
(43) Pub. Date: Aug. 13, 2026

(54) UE OPERATION ON NTN TN CELL RESELECTION

(71) Applicant: Apple Inc., Cupertino, CA (US)

(72) Inventors: Fangli XU, Beijing (CN); Ralf ROSSBACH, Munich (DE); Peng CHENG, Beijing (CN); Naveen Kumar R. PALLE VENKATA, San Diego, CA (US); Haijing HU, Los Gatos, CA (US); Alexander SIROTKIN, Hod HaSharon (IL); Yuqin CHEN, Beijing (CN)

(21) Appl. No.: 19/154,544

(22) PCT Filed: Feb. 10, 2023
(86) PCT No.: PCT/CN2023/075465

§ 371 Date: Aug. 7, 2025

(51) Int. Cl. H04W 36/32; H04B 17/318; H04W 36/00; H04W 36/08; H04W 76/20; H04W 84/06

(52) U.S. Cl. CPC H04W 36/32; H04B 17/328; H04W 36/0058; H04W 36/08; H04W 76/20; H04W 84/06

(57) ABSTRACT

User equipment (UE) in a 5G new radio (NR) environment may be configured to perform operations. A UE may camp on a non-terrestrial network (NTN). A UE may obtain coverage information of a terrestrial network (TN) cell. A UE may perform a neighbor cell measurement of the TN cell with a cell reselection algorithm. Other aspects are described.

### FIELD OF INVENTION

This invention relates generally to wireless technology and more particularly to communications involving a non-terrestrial network (NTN) and terrestrial network (TN).

### BACKGROUND OF THE INVENTION

Fifth generation mobile network (5G) is a wireless standard that aims to improve upon data transmission speed, reliability, availability, and more. The wireless standard includes numerous procedures that may be implemented by a transmitting device or a receiving device that improves the latency, the speed, and the reliability of uplink and downlink transmissions.

### SUMMARY OF THE DESCRIPTION

Aspects of the present disclosure relate to 5G new radio (NR) operating in the licensed spectrum or in the shared and unlicensed spectrum (NR-U).

In one aspect, a method performed by user equipment (UE) in a 5G new radio (NR) environment includes camping on a non-terrestrial network (NTN) cell of a network; obtaining, through the NTN cell, coverage information associated with a terrestrial network (TN) cell; and storing the coverage information associated with the TN.

In one aspect, a method performed by user equipment (UE) in a 5G new radio (NR) environment, includes camping on a non-terrestrial network (NTN) cell of a network; in response to a first condition being satisfied, determining if terrestrial network (TN) coverage is available on the network; in response to determining that the TN coverage is available, performing TN neighbor measurement of a TN cell based on a cell reselection algorithm, wherein the UE determines whether to stay camped on the NTN cell or to move to the TN cell based on the TN neighbor measurement.

In some aspects, a user equipment (UE), may have a processor that is configured to perform operations described. In some aspects, a processor (e.g., a baseband processor) can be configured to perform the methods described. The processor can execute instructions stored in a computer readable medium (e.g., one or more computer programs) to perform such methods. Other aspects are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some aspects.

FIG. 2 illustrates uplink and downlink communications according to some aspects.

FIG. 3 illustrates an example block diagram of a UE according to some aspects.

FIG. 4 illustrates an example block diagram of a BS according to some aspects.

FIG. 5 illustrates an example block diagram of cellular communication circuitry, according to some aspects.

FIG. 6 illustrates a general example of a non-terrestrial network and a terrestrial network, according to some aspects.

FIG. 7 illustrates a general example of a non-terrestrial network and coverage, according to some aspects.

FIG. 8 illustrates an example of a non-terrestrial network and terrestrial network with user equipment, according to some aspects.

FIG. 9 shows an example diagram of provisioning information associated with a terrestrial network when in coverage of a non-terrestrial network, according to some aspects.

FIG. 10 shows an example diagram of provisioning information associated with a terrestrial network when in coverage of a non-terrestrial network via broadcast, according to some aspects.

FIG. 11 shows an example diagram of performing terrestrial network information updates, according to some aspects.

FIG. 12 shows an example diagram of invalidating terrestrial network information in a non-terrestrial network environment, according to some aspects.

FIG. 13 shows an example diagram of invalidating terrestrial network information in a non-terrestrial network environment based on a timer, according to some aspects.

FIG. 14 and FIG. 15 show example diagrams with obtaining terrestrial network information in a non-terrestrial network environment, according to some aspects.

FIG. 16 shows an example workflow with performing a neighbor cell measurement on terrestrial network cell, according to some aspects.

### DETAILED DESCRIPTION

A method and apparatus of a device that determines a physical downlink shared channel scheduling resource for a user equipment device and a base station is described. In the following description, numerous specific details are set forth to provide thorough explanation of aspects of the present invention. It will be apparent, however, to one skilled in the art, that aspects of the present invention may be practiced without these specific details. In other instances, well-known components, structures, and techniques have not been shown in detail in order not to obscure the understanding of this description.

Reference in the specification to “some aspects” or “an aspect” means that a particular feature, structure, or characteristic described in connection with the aspect can be included in at least one aspect of the invention. The appearances of the phrase “in some aspects” in various places in the specification do not necessarily all refer to the same aspect.

In the following description and claims, the terms “coupled” and “connected,” along with their derivatives, may be used. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device may provide enhanced operation for situations where a user equipment (UE) device is under coverage of a non-terrestrial network (NTN) and may benefit from obtaining information with a terrestrial network (TN) or connecting with the TN, or both. In some aspects, the device is a user equipment device that has a wireless link with a non-terrestrial station, or a terrestrial base station, or both. In some aspects, the wireless link is a fifth generation (5G) link.

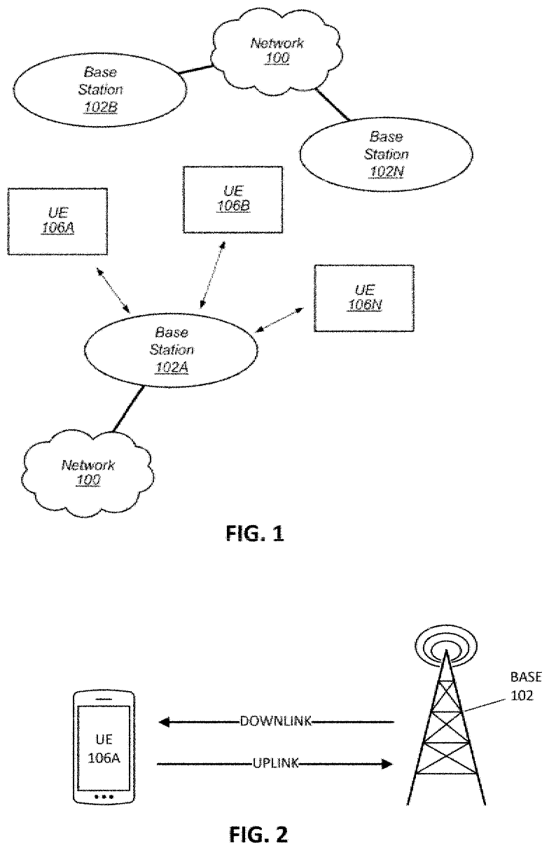

FIG. 1 illustrates a simplified example wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to as a “user equipment” (UE).

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates UE 106A that can be in communication with a base station 102 through uplink and downlink communications, according to some aspects. The UEs may each be a device with cellular communication capability such as a mobile phone, a hand-held device, a computer or a tablet, or virtually any type of wireless device.

The UE may include a processor that is configured to execute program instructions stored in memory. The UE may perform any of the method aspects described herein by executing such stored instructions. Alternatively, or in addition, the UE may include a programmable hardware element such as an FPGA (field-programmable gate array) that is configured to perform any of the method aspects described herein, or any portion of any of the method aspects described herein.

The UE may include one or more antennas for communicating using one or more wireless communication protocols or technologies. In some aspects, the UE may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE may include separate transmit and/or receive chains (e.g., including separate antennas and other radio components) for each wireless communication protocol with which it is configured to communicate. As a further possibility, the UE may include one or more radios which are shared between multiple wireless communication protocols, and one or more radios which are used exclusively by a single wireless communication protocol. For example, the UE might include a shared radio for communicating using either of LTE or 5G NR (or LTE or 1×RTT or LTE or GSM), and separate radios for communicating using each of Wi-Fi and Bluetooth. Other configurations are also possible.

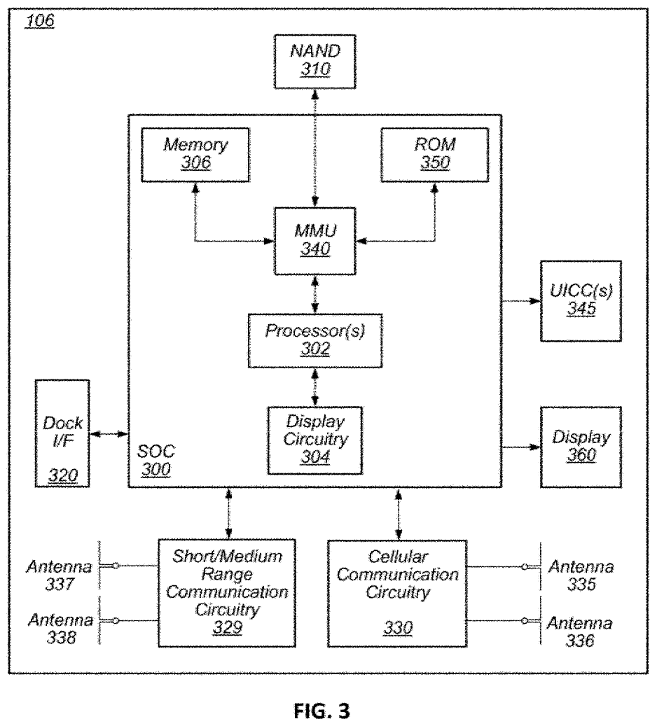

FIG. 3 illustrates an example simplified block diagram of a communication device 106, according to some aspects. It is noted that the block diagram of the communication device of FIG. 3 is only one example of a possible communication device. According to aspects, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC

(Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

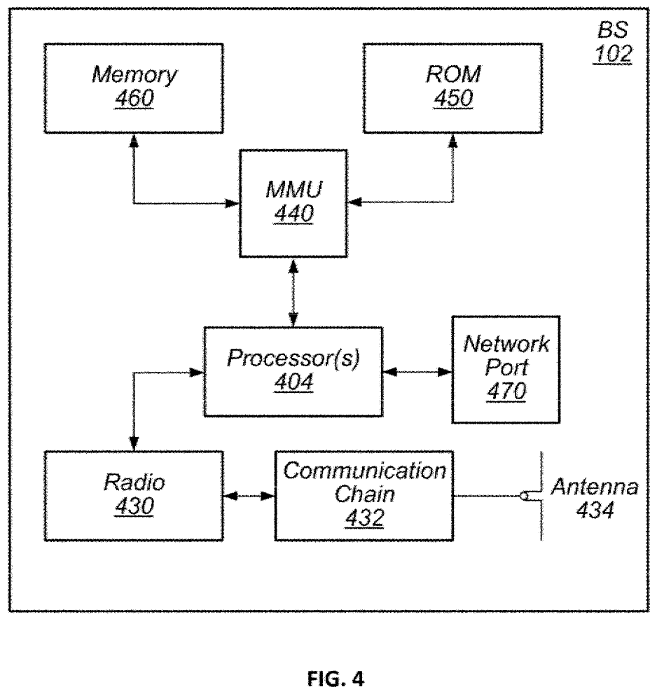

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs. In some aspects, the base station can operate in 5G NR-U mode.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, 5G NR-U, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR and 5G NR-U. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

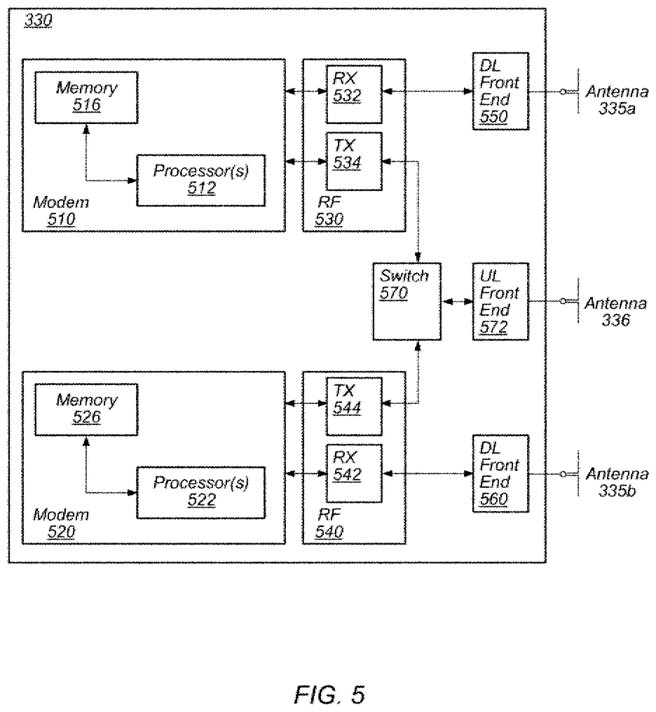

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some aspects, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for determining a physical downlink shared channel scheduling resource for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining a physical downlink shared channel scheduling resource for a user equipment device and a base station, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G supports multi-antenna transmission, beam-forming, and simultaneous transmission from multiple geographically separates sites. Channels of different antenna ports that are relevant for a UE may differ, for example, in terms of radio channel properties. QCL antenna port may be geographically separated.

5G physical channels provide flexible communication between the 5G base stations and the UEs. 5G NR has specified the physical channels for 5G networks that can be used either for Downlink or Uplink communication. 5G NR physical channels used for uplink communication includes the physical uplink shared channel (PUSCH), the physical uplink control channel (PUCCH), and the physical random-access channel (PRACH). Uplink signals such as DM-RS, PT-RS, and SRS are also supported. 5G NR supports the simultaneous transmission on PUSCH and PUCCH. PUSCH is typically used to carry the user data and optionally, can carry uplink control information (UCI).

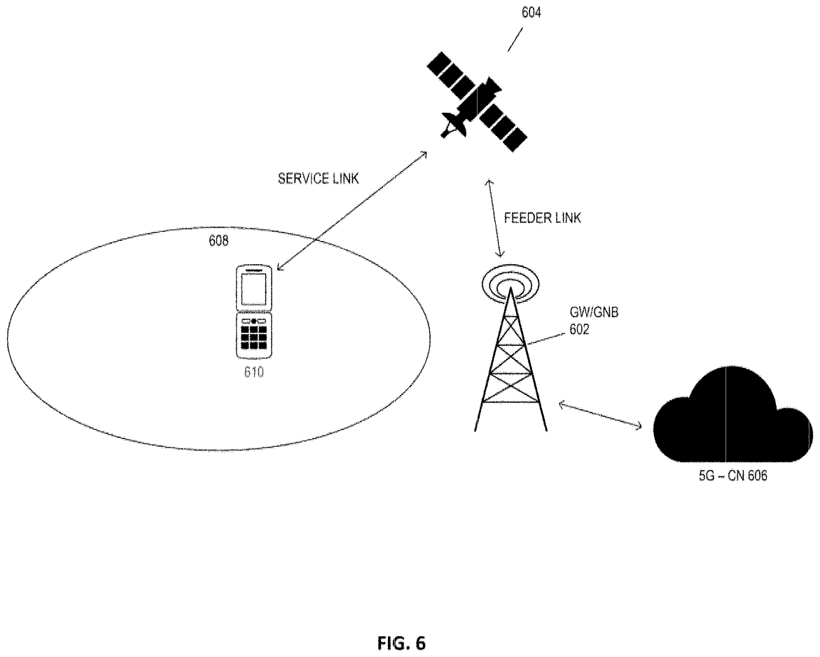

FIG. 6 illustrates a general example of a non-terrestrial network and a terrestrial network, according to some aspects. Use cases described in FIG. 6 and other figures may relate to a Non-Terrestrial Network (NTN). An NTN station 604 may provide coverage to a geographical area 608 (e.g., a cell 608) which UE 610 is within. The UE may be connected to the NTN station 604 over a service link (e.g., through a Uu interface). The NTN station 604 may be connected to gateway (GW) or gNodeB (GNB) 602 over a feeder link. GW/GNB 602 is coupled to or connected to a 5G core network (CN) 606 (e.g., using NG interface). NG Interface may be located between 5G radio access network (RAN) and 5G Core Network. The NG interface may include two planes, NG-C (core plane) and NG-U (user plane).

An NTN may refer to a network or networks, or segments of networks, that use an airborne or spaceborne vehicle for transmission. An NTN station may include a spaceborne vehicle such as, for example, low earth orbit (LEO)/medium-earth orbit (MEO)/geosynchronous equatorial orbit (GEO)/highly elliptical orbit (HEO) satellites, or other satellites. An NTN station may also include airborne vehicles such as HAPS (High Altitude Platforms). NTNs may be used to address mobile broadband needs and public safety needs in unserved/underserved areas such as maritime; airplane connectivity; railway, or other mobile situations.

In aspects of the present disclosure, New Radio (NR) NTN such as with LEO and GEO have compatibility to support HAPS and ATG (Air-To-Ground) scenarios. Scenarios may include frequency division duplex (FDD) and time division duplex (TDD) which may be applied for relevant scenarios e.g., HAPS, ATG. Scenarios may include Earth fixed tracking area, UEs with Global Navigation Satellite System (GNSS) capabilities, transparent payload, and handheld devices in frequency range 1 (FR1) (e.g., power class 3) or “VSAT” devices with external antenna at least in frequency range 2 (FR2) (see RAN1-3 specifications).

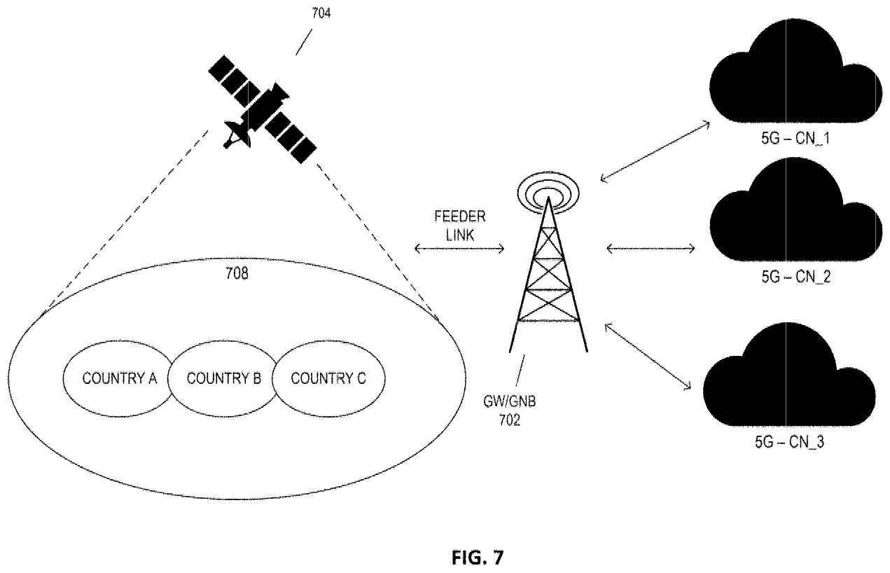

FIG. 7 illustrates a general example of a non-terrestrial network and coverage, according to some aspects. A NTN station 704 may provide coverage to an NTN cell 708. The NTN cell 708 may cover the wider radio cells. In NTN, the coverage of a cell or a beam may typically be much larger than the cell in the terrestrial networks (e.g., due to the height of the NTN station). The NTN 704 may be connected to GNB 702 over a feeder link. In some examples, the coverage of one NTN cell 708 may be across multiple countries (e.g., country A, country B, country C, etc.). Each country may be associated with a respective core network. For example, country A may be associated with 5G_CN_1, country B may be associated with 5G_CN_2, country C may be associated with 5G_CN_3, and so on. GNB 702 may be connected to each of the core networks.

The NTN network can broadcast multiple Public Land Mobile Network (PLMN) and multiple tracking area codes (TACs) per PLMN (e.g., up to a total of 12) in a single cell. A UE is not expected to perform a registration procedure if one of the currently broadcast TACs belongs to the UE's registration.

Aspects relate to NTN to TN communications and NTN to NTN mobility and service continuity enhancements. Aspects consider and improve on methods from NR TN as well as NT NTN WI outcome (Rel-17) as a baseline for NTN-TN mobility. Aspects may specify NTN-TN and NTN-NTN measurement/mobility and service continuity enhancements. For NTN-NTN mobility, aspects relate to specifying cell reselection enhancements for Earth moving cell. The timing based and location-based cell reselection for quasi-Earth fixed cells can be addressed.

3GPP progress may be furthered in view of aspects (e.g., in relation to RAN2 #119bis and RAN2 #120 agreements). To enhance NTN-TN cell reselection, aspects of the present disclosure include operations for a UE to perform. The operations may differentiate scenarios such as when camping in an area only covered by NTN network (earth-moving or earth-fixed) vs when the UE is camped in an area where a TN network (or networks) is also available. RAN2 may continue the investigation on the details of the TN coverage data (e.g., accuracy requirements for describing where TN network(s) is/are available) and UE storage overhead before deciding how to send the information to the UE. Progress may include continued discussions on whether to introduce explicit indication to identify TN cells from inter-frequency list and inter-RAT frequency list (FFS on the granularity) or whether to rely on implicit information. A UE is not required to perform neighbor cell measurements for TN neighbor cells in an area where there is no TN network coverage.

TN coverage information (e.g., a TN coverage area) of a TN cell within one NTN cell may be provided to a UE in one or more of the candidate formats as follows. In a first option, the cell center and cell radius of TN neighbor cells, or in other terms, the reference location and a distance threshold of TN neighbor cells. In a second option, the boundary line between TN area and NTN area. In a third option, for quasi-earth fixed cells, TN coverage is described by a distance range from the cell center and an angle range based on a reference direction. In a fourth option, an indication could be included in system information to indicate NTN cell's coverage overlaps with terrestrial TN cell's coverage. In a fifth option, the NTN cell can be divided to several virtual areas based on certain criteria, the virtual areas and the corresponding TN frequency information are broadcast as assistance information to help UE perform more accurate TN measurements. In a sixth option, the TN coverage information may include a parameter using the polygon shape captured in TS 23.032 to describe the coverage area of a TN neighbor cell.

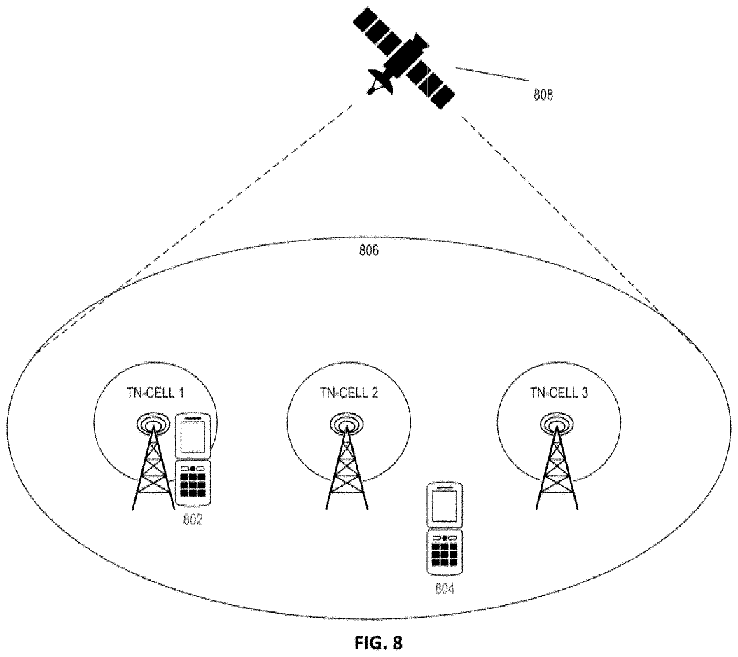

FIG. 8 illustrates an example of a non-terrestrial network and terrestrial network with user equipment, according to some aspects. FIG. 8 illustrates possible issues related to NTN cell and UE. UE 802 and UE 804 may be camped on NTN cell 806. A UE may be said to be camping on a cell when the UE is coupled to and initiates the connection access to a station that supports the servicing cell, (e.g., the NTN station 808)

NTN 808 supports coverage over an NTN cell 806 which includes one or more TN cells such as TN-CELL 1, TN-CELL 2, and TN-CELL 3. UEs such as UE 802 and UE 804 fall within coverage of NTN cell 806 and may also transition in and out of any of the TN cells within the NTN cell 806. For example, UE 802 may be within TN-CELL 1 as well as NTN 806. UE 804 may be outside of the TN cells, but within NTN 806.

Various issues may arise. For example, a first issue that arises is how will the overall network provide the TN coverage information to a UE (that is within the NTN cell). For example, UE 802 may benefit from TN coverage information of TN-CELL 1 so that UE 802 may determine whether or not to switch to TN-CELL 1. Similarly, UE 804 may benefit from obtaining TN information about TN-CELL 2 or TN-CELL 3, or other TN cells, to make similar determinations, given that UEs may move in and out of TN cell coverage while remaining covered by the same NTN cell.

A second issue that arises is with regard to UE performing TN neighbor measurements. For example, how is the UE 802 or 804 to behave if there is no network (NW) assistance information on the TN coverage area or if the NW assistance information is not accurate. Aspects are described to address the above issues, as well as other related issues.

A UE 802 or 804 may automatically perform the neighbor TN cell measurement in response to if a frequency is configured for cell reselection and mobility purpose. For example, UE 802 may perform a legacy cell reselection algorithm with neighbor measurements on TN cell to determine whether or not to stay on NTN cell 806 or to transition to TN-cell 1. Similarly, UE 804 may implement a legacy cell reselection mechanism with neighbor measurements on TN cell to determine whether to stay on NTN cell 806 or transition to any of the TN cells within the NTN cell 806. Neighbor TN cell measurement more generally may include measuring signal quality of a cell (e.g., a TN cell) via measuring the (Reference Signal Received Power) RSRP or (Reference Signal Received Quality) RSRQ of the neighbor cell. These measurements may be determined based on a measured reference signal from the neighbor cell. The network (e.g., through RRC) may provide the UE with measurement parameters such as frequency, subcarrier spacing, measurement timing. It is considered, however, that the legacy cell reselection mechanism may not be ideal under all circumstances. For example, there may be no overlap between the NTN cell and a TN neighbor cell, or there may be no neighbor TN cells adjacent to the NTN cell. In such a case, the measurement on TN neighbor cell may unnecessarily consume energy of UE 804. A legacy cell reselection may include intra-frequency cell reselection, or inter-frequency cell reselection. The legacy cell reselection may include cell ranking criterion R for intra-frequency or inter-frequency with equal priority. Cell ranking criterion R may include, for example:

The cell-ranking criterion Rₛ for serving cell and Rₙ for neighbouring cells is defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp}$$

where:

| | |
|---|---|
| Qₘₑₐₛ | RSRP measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is |
| | valid, otherwise this equals to Qoffset_{frequency}. |
| Qoffsetₜₑₘₚ | Offset temporarily applied to a cell as specified in |
| | TS 38.331 [3]. |

Under the legacy NR cell reselection mechanism, two parameters may be used for prioritizing cell reselection: frequency priority; an offset in cell ranking criterion R, which may include frequency-offset and cell-offset. The below table shows an example of legacy NR cell reselection mechanism with respect when to perform a neighbor measurement with respect to frequency priority and reselection criteria.

TABLE 1
Legacy Cell Reselection Mechanism

| | CONDITION TO | |
|---|---|---|
| | TRIGGER | |
| CASE | MEASUREMENT | RESELECTION CRITERIA |
| Intra-frequency | Serving cell quality | Criterion R |
| | below threshold | |
| Inter-frequency - | N/A | cell quality > threshold for a |
| high priority | | time duration |
| Inter-frequency - | Serving cell quality | Criterion R |
| equal priority | below threshold | |
| Inter-frequency - | Serving cell quality | serving cell: quality < threshold; |
| Low priority | below threshold | target cell: quality > threshold |

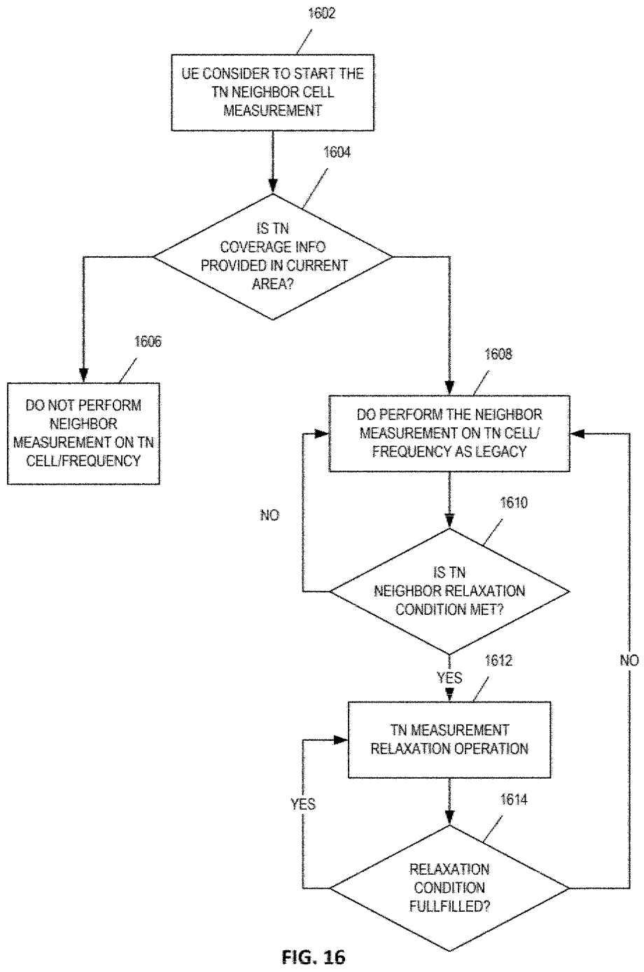

As such, the cell reselection mechanism described may provide at least two functions. It may provide when the measurement of neighbor cell is triggered in different cases (e.g., an intra-frequency channel, an inter-frequency channel, based on priority of the channel frequency). It may also provide what the reselection criterion is to use in determining whether to switch from the current serving cell to the neighbor cell, which may change based on the cases. The network may provide a priority per frequency/channel to a UE, e.g., via a dedicated msg or via broadcast. As discussed, however, the legacy cell reselection mechanism may not be ideal under all circumstances. Aspects described (e.g., in FIG. 16) may adjust how a neighbor measurement is performed while camped on an NTN cell, thereby preserving UE energy under some conditions.

The network may provide provisioning information (e.g., neighbor cell coverage information) to the UE. The information provision method includes the following considerations. Consideration 1: signaling load of the information provision—the more detailed and accurate the TN coverage information is provided, the greater the signaling load. Consideration 2: security/privacy of the information provision—the TN coverage information reflects network deployment by operators. With this information, we may gain understanding of the relevant deployment of the entire network. Therefore, the transmission of this information should consider a certain degree of security/privacy.

Generally, the TN coverage information provision may include various considerations that may drive one or more directions of implementation. Some directions are described below.

A first direction includes a signaling load perspective. Under this direction, NW can provide the coarse info to UE. Alternatively, or additionally, NW can only provide UE part of the TN coverage information, which is related to the UE location, when the UE moves to another area, NW needs to provide the update of the TN coverage info of the new area to UE. TN coverage information may be provided by NW based on UE request. Alternatively, or additionally, the TN coverage info could be sent in a compressed format or provided as the delta signaling method, using some data compression algorithm (e.g., DEFLATE (based on RFC 1951), which is also used in unified data convergence (UDC)).

A second direction considers a security perspective. NW can provide the information to UE in the secured way. In one aspect, the NW may provide the info to UE via the UE dedicated RRC signaling after AS security is activated. In another aspect, the NW may provide the secured protection on the system information which is for the TN info transmission. In another aspect, the UE requests the TN coverage info from NW, and NW can provide it via NAS (i.e., after security is activated).

Various key points are worth mentioning with respect to provisioning of TN coverage information to a UE in the context of a NTN network.

A first point includes signaling design. NW provides the TN coverage info to UE via following signaling options. These signaling options may be described in terms of UE dedicated transmission, or in terms of broadcast transmission.

With UE dedicated transmission may include UE dedicated AS RRC signaling where Server/CN provides the info to gNB, and gNB provides it to UE via the RRC container; UE dedicated NAS signaling; and UE dedicated data transmission (e.g., Server delivers the data to UE via the user plane).

Broadcast transmission may include system information. System information may be included in a system information block (SIB) such as SIB19 or in a new SIB. A SIB may carry information relevant to evaluating if a UE is allowed to access a cell and may define scheduling of other system information.

A second point includes that the NW provides full set or subset of the TN coverage info to UE. For the subset of the TN coverage info provision, NW can provide the info to the UE based on the UE present location. When UE is released to IDLE/INACTIVE state, NW can provide the TN info via RRCRelease message based on UE location. When UE moves to another area, UE can request NW to provide the updated TN coverage info related to the new area. The UE can read the SIB to acquire the TN info only when necessary, with the assumption that NW broadcast the different TN info in different area within the same NTN cell. The validity of TN info can be judged by timer or location. For the subset of the TN coverage info provision, NW can provide the provision info based on UE present location. It should be noted that, for the NTN cell, which is configured with multiple PLMN list, NW can provide the TN coverage info per PLMN.

A third point includes providing security protection on the TN coverage info provision. Various options may be realized for such security protection.

Under a first option, the NW provides the info to UE via the UE dedicated RRC signaling after AS security is activated. Under a second option, the security protection method may be implemented to protect the info carried in the system information, e.g., signature-based method. The method of the encrypted SIB as in posSIB can be reused here. In a third option, system info may provide only the coarse info about the TN coverages, e.g., 1 bit to indicate whether there is TN coverage in a particular area. Area info can be provided via RRC dedicated signaling. Detailed information may be omitted in provisioning information, to reduce exposure of sensitive network information.

Regarding the issue of provisioning of TN coverage information to a UE, one example considers that an NTN NW provides the full set of the TN coverage info to UE.

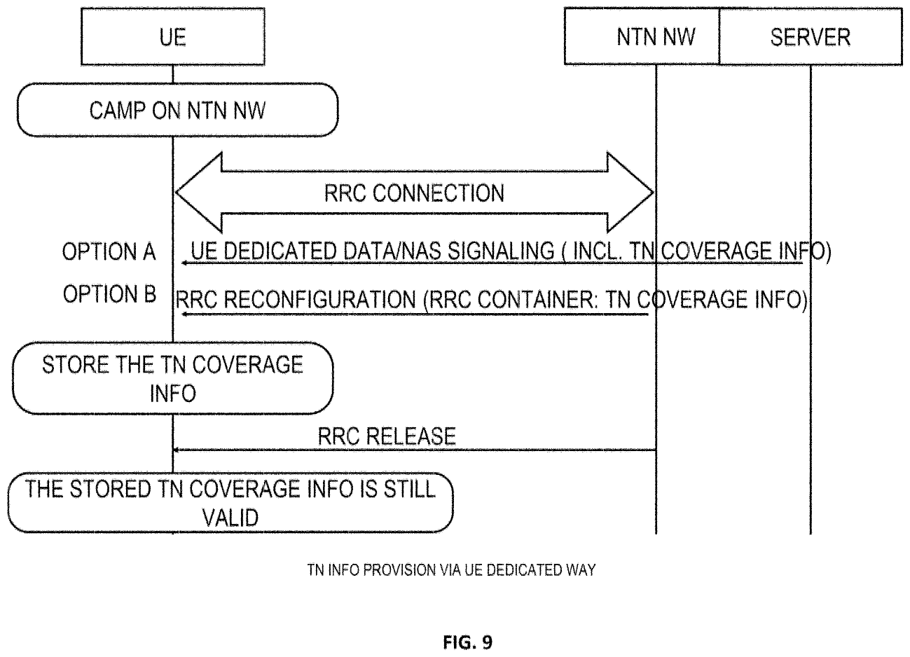

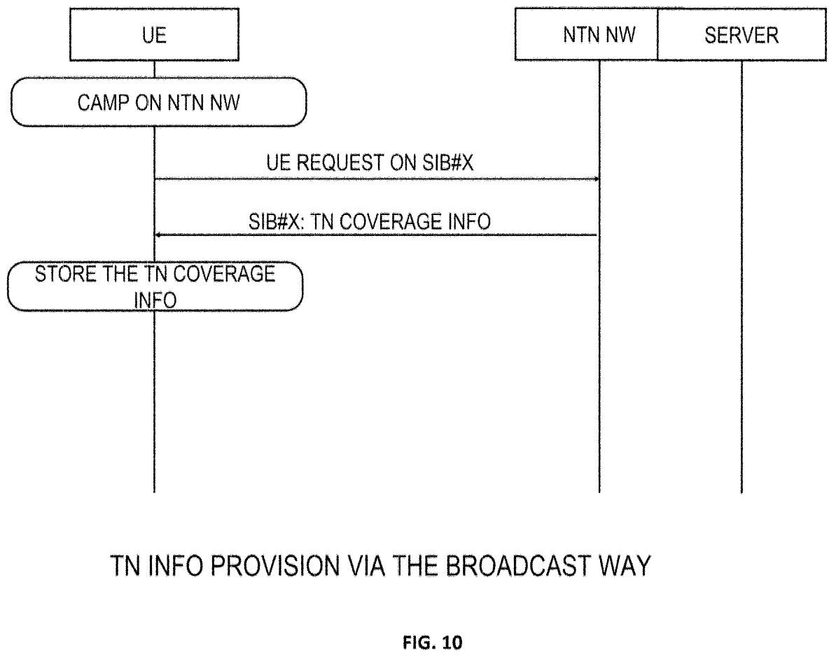

FIG. 9 and FIG. 10 show two options for dealing with such a scenario with the NTN NW providing a full set of TN coverage information to the UE.

FIG. 9 shows an example diagram of provisioning information associated with a terrestrial network when in coverage of a non-terrestrial network, according to some aspects. In some aspects, a UE may be camped on an NTN network. The NTN NW may provide the full set of the TN coverage info to the UE.

Under this example, the provisioning information may be provided to the UE via UE dedicated signaling. This may include communications between the UE and the network such as, for example, RRC signaling or NAS signaling. The signaling may include the messages between the UE, the NTN network, and a server, as shown in detail in FIG. 9. One option is the server may use UE dedicated data and/or NAS signaling that includes TN coverage information. A second option is that the NTN NW may use RRCReconfiguration to include TN coverage information (e.g., in an RRC container). The UE may receive the TN coverage information which may include the covered channels, area of coverage, and/or other TN coverage information. Upon RRC release communicated from the NTN NW to the UE, the stored TN coverage info may be maintained as valid in the UE.

FIG. 10 shows an example diagram of provisioning information associated with a terrestrial network when in coverage of a non-terrestrial network via broadcast, according to some aspects. In some aspects, a UE may be camped on an NTN network. The NTN NW may provide the full set of the TN coverage info to the UE.

Under this example, the provisioning information may be provided to the UE via broadcast info. This framework may support the segment transmission, support the UE request on demand provision. UE may communicate a request on a SIB. The NTN NW may communicate the corresponding SIB, which may include the TN coverage information. For example, the UE may request SIB #X. NTN NW may provide SIB #X with the TN coverage information.

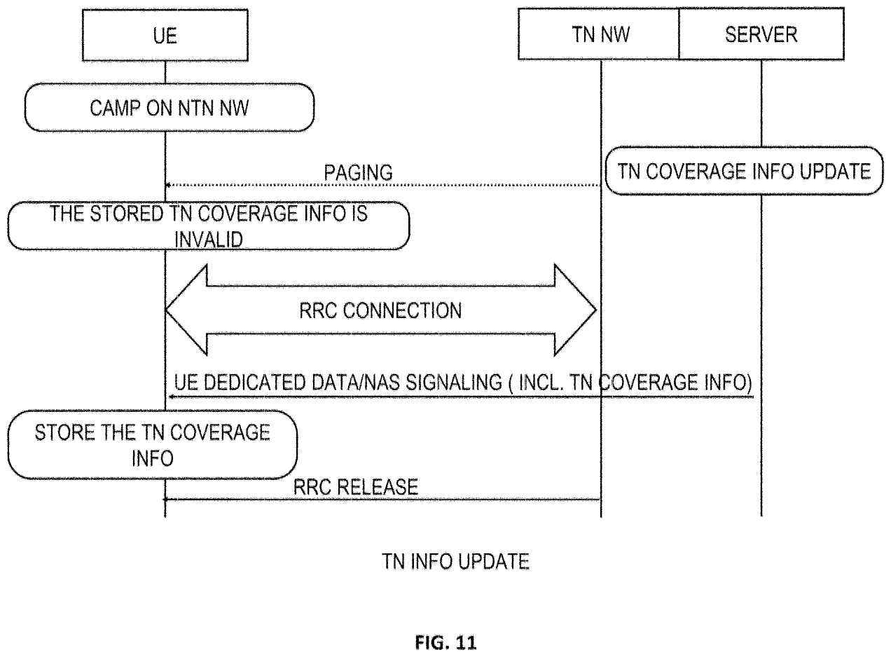

FIG. 11 shows an example diagram of performing terrestrial network information updates, according to some aspects. A UE may be camped on an NTN network. The NTN NW may provide the full set of the TN coverage info to the UE. A UE may be said to be camped on a network when the UE is connected to and coupled to a station (e.g., an NTN station or a TN station).

The TN coverage information may, in some aspects, be updated on the NW side and/or server side. Aspects may address such a situation with number of options such as those below. Under a first option, TN NW pages the UE back to the CONNECTED state, and provides the updated info to UE via the dedicated link. Under a second option, TN NW does not page the UE dedicated for this updated event, but provides the updated info to UE when UE enters CONNECTED state next time. Under a third option, the UE may rely on the SIB update/modification procedure (applicable for the broadcast approach) for updated TN coverage information.

In another example, the NW provides a given area (e.g., area #1) with related TN coverage info to UE via RRCRelease message to UE. The UE stores the TN info and uses it for the TN neighbor cell measurement. UE may assume the TN info is invalid in the following two conditions: a) when the UE moves out of the current area, UE assumes the provided TN coverage info is invalid; b) when the valid timer of the provided TN coverage info expires, UE assume the provided TN info is invalid.

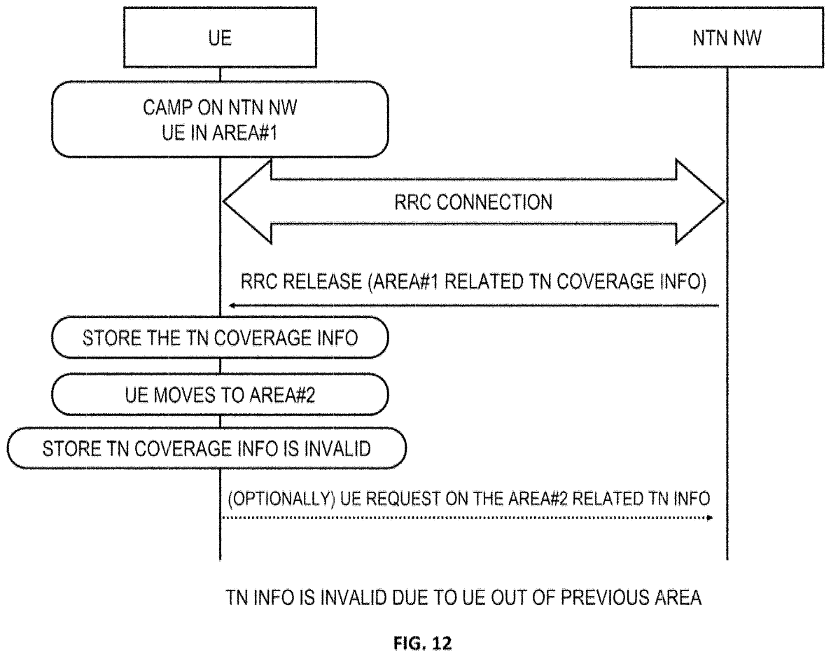

FIG. 12 shows an example diagram of invalidating terrestrial network information in a non-terrestrial network environment, according to some aspects. The example shows UE behavior when the UE moves out of the current area and assumes the provided TN coverage information is invalid.

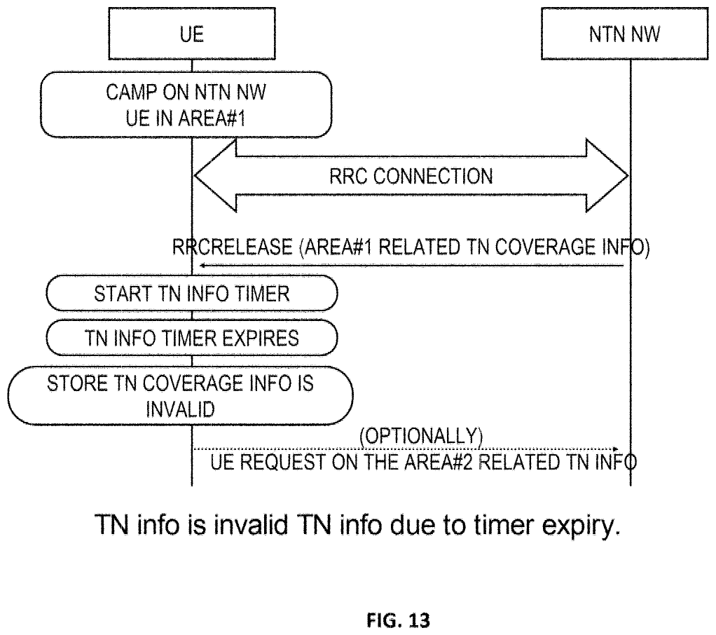

FIG. 13 shows an example diagram of invalidating terrestrial network information in a non-terrestrial network environment based on a timer, according to some aspects. The example shows the UE invalidating the TN coverage information in response to the timer expiring.

In both examples shown in FIG. 12 and FIG. 13, when the stored TN coverage info is invalid, UE may perform one or more of the following options: a) UE initiates access to request the TN coverage infob) UE uses the coarse info provided in system info; or c) UE assumes no TN coverage info is provided by NW.

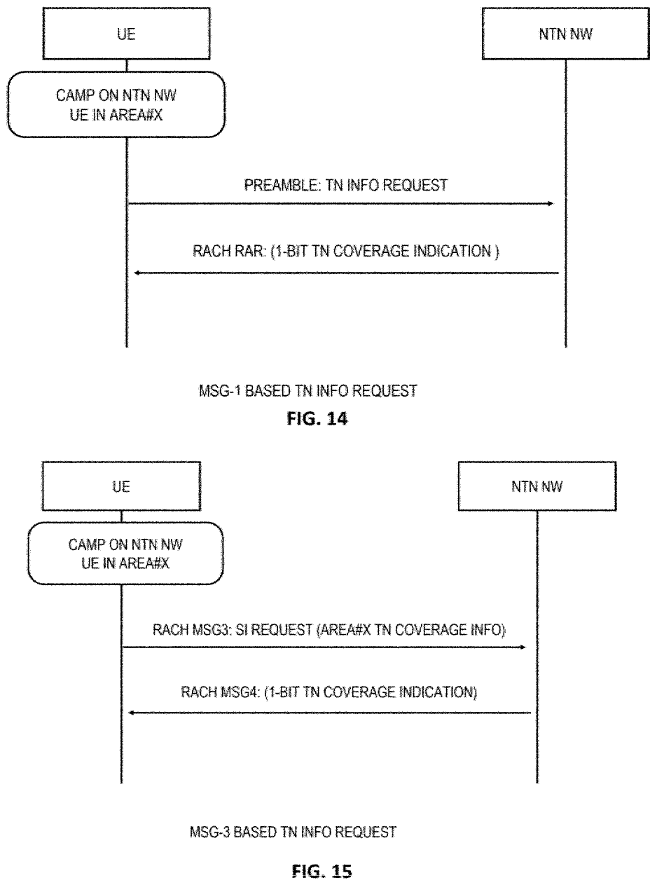

FIG. 14 and FIG. 15 show example diagrams with obtaining terrestrial network information in a non-terrestrial network environment, according to some aspects.

A UE that is camped on an NTN network may send a UE request on the TN coverage info.

For CONNECTED UE, UE can provide the request to the NTN network via UE dedicated RRC message, e.g., UE assistance information.

In the case of an IDLE/INACTIVE UE, UE can perform the following operations. Under a first option, UE initiates the SI request for the corresponding SIB (NOTE: for the TN coverage info provided via broadcast). Under a second option, UE initiates the request with the location info to request the area/location specific TN coverage info. Under the second option, FIG. 14 shows an example where the NW can provide the area specific TN coverage info to the UE via SDT procedure, paging message, response message to UE request. Also under the second option, FIG. 15 shows that the NW can just indicate 1-bit indication to inform UE whether there is TN coverage per area, or indicate the detail info of the TN coverage. For the 1-bit indication, area division can be provided in advance via UE dedicated signaling. Under a third option, the UE initiates the RRC Connection to acquire the TN coverage info.

FIG. 16 shows an example workflow with performing a neighbor cell measurement on terrestrial network cell, according to some aspects. Aspects of the workflow may relate to issue two, which may describe UE operation of TN neighbor measurements in an NTN environment.

At block 1602, when at least one of the following conditions is met, UE can consider starting the TN neighbor cell measurement. Conditions at block 1602 may include: condition 1) TN frequency has higher priority for measurement; condition 2) TN frequency has higher priority for measurement, and the TN frequency measurement state is not in relax state; condition 3) RSRP and/or RSRQ of serving cell satisfies a TN specific measurement threshold; or condition 4) RSRP and/or RSRQ of serving cell satisfies a general threshold to start the neighbor measurement (as legacy). The general threshold or TN specific measurement threshold may be satisfied when the RSRP and/or RSRQ is not less than the threshold (e.g., greater than or equal to).

At block 1604, UE checks whether there is TN coverage in current area, and decides to start the TN neighbor cell measurement. If TN coverage is in current area, UE proceeds to block 1608 and starts the TN neighbor cell measurement. The UE may determine the TN coverage based on aspects described (e.g., obtaining coverage information of neighbor TN cell). If none of the conditions at block 1604 are met, the UE may proceed to block 1606 and does not perform neighbor measurement on TN cell or frequency. It should be noted that if the UE does not acquire the TN coverage info from NW (e.g., gNB does not provide any TN coverage info in current serving cell), the UE may still decide that the TN coverage might exist in current area and proceed to block 1608.

At block 1608, the UE may perform the neighbor measurement on the TN cell. The UE perform the neighbor measurement based on the legacy NR cell reselection algorithm. For example, it may select the trigger mechanism and the reselection criteria based on the frequency (intra-frequency, inter-frequency, and/or priority of inter-frequency reselection). The measurement may be performed periodically (e.g., according to a legacy rate).

At block 1610, the UE may determine whether or not to relax the neighbor measurement based on whether a relaxation condition is satisfied. For example, performing the measurements as dictated by the cell reselection algorithm of block 1608 may unnecessarily drain the UE of energy. Thus, the UE can relax this operation if one or more relaxation conditions are satisfied. In some aspects, the relaxation condition is satisfied when at least one of the following conditions are satisfied (e.g., for X period of time): condition 1) radio quality of the neighbor TN cell is less than a threshold; or condition 2) the UE cannot detect the downlink (DL) reference signal (RS) of the neighbor TN cell (e.g., CSI-RS). In response to at least one of these being met, the UE may proceed to block 1612.

At block 1612, the UE may perform the following one or more of the operations optionally: option 1) UE stops the neighbor measurement on TN cell/frequency for Y period of time (and then may resume the measurement); option 2) UE extends the measurement cycle on the TN cell/frequency; or option 3) UE deprioritizes the TN cell/frequency for measurement. The period Y may be different (e.g., greater) than the legacy frequency.

At block 1614, the UE is in relaxation mode, meaning that it is not performing a neighbor measurement on TN cell in accordance with the reselection algorithm of block 1608. During the relaxation mode, the UE may continue to check if the relaxation condition (e.g., at 1610) is met. If the relaxation condition is not fulfilled for at least one time or for Y period, UE may proceed back to block 1608 and perform neighbor measurement according to the reselection algorithm. Otherwise, if the relaxation condition is still satisfied, the UE may remain in relaxation mode, which may include performing the neighbor measurement at a reduced rate, or according to a different reselection algorithm.

It should be understood that aspects described with respect to one issue or example may be combined with aspects described with another issue or example, without departing from the scope of the present disclosure.

Some aspects of the present disclosure are described below.
1. A method performed by user equipment (UE) in a 5G new radio (NR) environment, comprising: camping on a non-terrestrial network (NTN) cell of a network; obtaining, through the NTN cell, coverage information associated with a terrestrial network (TN) cell; and storing the coverage information associated with the TN. For example, see FIGS. 9-15. The coverage information (e.g., provisioning information) may be obtained through various described operations. Coverage information may include one or more of the candidate formats described.
2. The method of aspect 1, wherein obtaining the coverage information associated with the TN cell comprises establishing a radio resource control (RRC) connection through the NTN network; receiving, through the NTN cell, the coverage information associated with the TN over the RRC connection; and releasing the RRC connection. For example, see FIG. 9.
3. The method of aspect 2, wherein the coverage information is received over the RRC connection as part of a NAS message or a RRC reconfiguration message. For example, see FIG. 9, option A and option B.
4. The method of claim 1, wherein obtaining the coverage information associated with the TN coverage comprises transmitting, through the NTN cell, a request for a system information block (SIB) associated with the coverage information; and receiving the SIB as a broadcast through the NTN cell, the SIB including the coverage information associated with the TN. For example, see FIG. 10.
5. The method of aspect 1, further comprising:
receiving a paging message from the TN cell, the paging message including updated coverage information associated with the TN cell;
in response to receiving the paging message, establishing an RRC connection with the TN cell; and
obtaining updated coverage information through the RRC connection. For example, see FIG. 11.
6. The method of aspect 1, further comprising, in response to entering a connected state, receiving updated coverage information. For example, the network may not page the UE that is associated with this update event, and instead provides updated coverage information to the UE in response to the next time the UE enters the ‘connected’ state.
7. The method of aspect 1, further comprising receiving updated coverage information through a system information block (SIB). This may be received via a broadcast message from TN or NTN cell.
8. The method of aspect 1, further comprising:
in response to detecting the UE has moved out of an area associated with the TN cell while in coverage of the NTN cell, flagging the coverage information associated with the TN cell as invalid; and
in response to the coverage information associated with the TN cell being invalid, performing one or more of: initiating a request to the NTN cell to obtain new TN coverage information; using course information associated with the TN coverage information to determine the TN coverage information;
or deeming that TN coverage information is not available from the network. For example, see FIG. 12.
9. The method of aspect 1, further comprising:
starting a timer in response to obtaining the coverage information associated with the TN cell;
in response to expiration of the timer, flagging the coverage information associated with the TN cell as invalid; and
in response to the coverage information associated with the TN cell being invalid, performing one or more of: initiating a request to the NTN cell to obtain new TN coverage information; using course information associated with the TN coverage information to determine the TN coverage information; or deeming that TN coverage information is not available from the network. For example, see FIG. 13.
10. The method of aspect 1, further comprising:
in response to the UE being in an idle state or inactive state, initiating a request for the TN coverage information associated with a location; and
receiving the TN coverage information over the NTN cell sent in response to the request. For example, see FIG. 15 or FIG. 16, using random access channel (RACH) message 3 for request and RACH message 4 for receiving course coverage information (e.g., a 1-bit indicator showing only whether coverage is present).
11. A method performed by user equipment (UE) in a 5G new radio (NR) environment, comprising:
camping on a non-terrestrial network (NTN) cell of a network;
in response to a first condition being satisfied, determining if terrestrial network (TN) coverage is available on the network;
in response to determining that the TN coverage is available, performing TN neighbor measurement of a TN cell (e.g., in accordance with a cell reselection algorithm), wherein the UE determines whether to stay camped on the NTN cell or to move to the TN cell based on the TN neighbor measurement (e.g., as specified by the cell reselection algorithm). For example, see generally FIG. 16. The cell reselection algorithm may include the legacy cell reselection algorithm as described in other sections.
12. The method of aspect 11, wherein the first condition includes at least one: a TN frequency having a measurement priority that satisfies a threshold; the TN frequency having the measurement priority that satisfies the threshold and a TN frequency measurement state is not in a relax state; a reference signal received power (RSRP) or reference signal received quality (RSRQ) of the TN cell satisfying a TN measurement threshold; or the RSRP or the RSRQ of the TN cell satisfying a general threshold associated with starting the TN neighbor measurement. For example, the conditions may be checked at block 1602.
13. The method of aspect 11, wherein determining if the TN coverage is available on the network comprises obtaining TN coverage information over the NTN cell. Obtaining the TN coverage information may include any of aspects 1-10. In some cases, coverage information may be obtained from the TN neighbor cell, as described.
14. The method of aspect 11, further comprising in response to the TN neighbor measurement satisfying a second condition, relaxing the TN neighbor measurement. For example, FIG. 16 blocks 1610 and 1612.
15. The method of aspect 14, wherein the second condition comprises a radio quality of the TN cell not satisfying a quality threshold.
16. The method of aspect 14, wherein the second condition comprises detecting an absence of a downlink (DL) reference signal (RS) of the TN cell.
17. The method of aspect 14, wherein relaxing the TN neighbor measurement includes stopping the neighbor measurement for a period of time.
18. The method of aspect 14, wherein relaxing the TN neighbor measurement includes performing the TN neighbor measurement at a reduced rate.
19. The method of aspect 14, wherein relaxing the TN neighbor measurement includes deprioritizing the TN neighbor measurement.
20. The method of aspect 14, further comprising, in response to the TN neighbor measurement no longer satisfying the second condition, performing the TN neighbor measurement of the TN cell (e.g., in accordance with the cell reselection algorithm). For example, see FIG. 16, block 1614.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

A baseband processor (also known as baseband radio processor, BP, or BBP) is a device (a chip or part of a chip) in a network interface that manages radio functions, such as communicating (e.g., TX and RX) over an antenna.

An article of manufacture may be used to store program code. An article of manufacture that stores program code may be embodied as, but is not limited to, one or more memories (e.g., one or more flash memories, random access memories (static, dynamic, or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary aspects of the present invention. One skilled in the art will readily recognize from such discussion, the accompanying drawings and the claims that various modifications can be made without departing from the spirit and scope of the invention.

1. A method performed by a user equipment (UE) in a 5G new radio (NR) environment, comprising:
camping on a non-terrestrial network (NTN) cell of a network;
obtaining, through the NTN cell, coverage information associated with a terrestrial network (TN) cell; and
storing the coverage information associated with the TN.

2. The method of claim 1, wherein obtaining the coverage information associated with the TN cell comprises;
establishing a radio resource control (RRC) connection through the NTN network;
receiving, through the NTN cell, the coverage information associated with the TN over the RRC connection; and
releasing the RRC connection.

3. The method of claim 2, wherein the coverage information is received over the RRC connection as part of a non-access stratum (NAS) message or a RRC message.

4. The method of claim 1, wherein obtaining the coverage information associated with the TN coverage comprises:
transmitting, through the NTN cell, a request for a system information block (SIB) associated with the coverage information; and
receiving the SIB as a broadcast through the NTN cell, the SIB including the coverage information associated with the TN.

5. The method of claim 1, further comprising:
receiving a paging message from the TN cell, the paging message including updated coverage information associated with the TN cell;
in response to receiving the paging message, establishing an RRC connection with the TN cell; and
obtaining updated coverage information through the RRC connection.

6. The method of claim 1, further comprising, in response to entering a connected state:
receiving updated coverage information.

7. The method of claim 1, further comprising:
receiving updated coverage information through a system information block (SIB).

8. The method of claim 1, further comprising:
in response to detecting the UE has moved out of an area associated with the TN cell while in coverage of the NTN cell, flagging the coverage information associated with the TN cell as invalid; and
in response to the coverage information associated with the TN cell being invalid, performing one or more of: initiating a request to the NTN cell to obtain new TN coverage information; using course information associated with the TN coverage information to determine the TN coverage information; or deeming that TN coverage information is not available from the network.

9. The method of claim 1, further comprising:
starting a timer in response to obtaining the coverage information associated with the TN cell;
in response to expiration of the timer, flagging the coverage information associated with the TN cell as invalid; and
in response to the coverage information associated with the TN cell being invalid, performing one or more of: initiating a request to the NTN cell to obtain new TN coverage information; using course information associated with the TN coverage information to determine the TN coverage information; or deeming that TN coverage information is not available from the network.

10. The method of claim 1, further comprising:
in response to the UE being in an idle state or inactive state, initiating a request for the TN coverage information associated with a location; and
receiving the TN coverage information over the NTN cell sent in response to the request.

11. A method performed by a user equipment (UE) in a 5G new radio (NR) environment, comprising:
camping on a non-terrestrial network (NTN) cell of a network;
in response to a first condition being satisfied, determining if terrestrial network (TN) coverage is available on the network; and
in response to determining that the TN coverage is available, performing TN neighbor measurement of a TN cell based on a cell reselection algorithm, wherein the UE determines whether to stay camped on the NTN cell or to move to the TN cell based on the TN neighbor measurement.

12. The method of claim 11, wherein the first condition includes at least one of: a TN frequency having a measurement priority that satisfies a threshold; the TN frequency having the measurement priority that satisfies the threshold and a TN frequency measurement state is not in a relax state; a reference signal received power (RSRP) or reference signal received quality (RSRQ) of the TN cell satisfying a TN measurement threshold; or the RSRP or the RSRQ of the TN cell satisfying a general threshold associated with starting the TN neighbor measurement.

13. The method of claim 11, wherein determining if the TN coverage is available on the network comprises obtaining TN coverage information over the NTN cell.

14. The method of claim 11, further comprising:
in response to the TN neighbor measurement satisfying a second condition, relaxing the TN neighbor measurement.

15. The method of claim 14, wherein the second condition comprises a radio quality of the TN cell not satisfying a quality threshold.

16. The method of claim 14, wherein the second condition comprises detecting an absence of a downlink (DL) reference signal (RS) of the TN cell.

17. The method of claim 14, wherein relaxing the TN neighbor measurement includes stopping the neighbor measurement for a period of time.

18. The method of claim 14, wherein relaxing the TN neighbor measurement includes performing the TN neighbor measurement at a reduced rate.

19. The method of claim 14, wherein relaxing the TN neighbor measurement includes deprioritizing the TN neighbor measurement.

20. The method of claim 14, further comprising:
in response to the TN neighbor measurement no longer satisfying the second condition, performing the TN neighbor measurement of the TN cell based on the cell reselection algorithm.
